(19) United States
(12) Patent Application Publication
(10) Pub. No.: US 2011/0100238 A1
(43) Pub. Date: May 5, 2011

(54) Internet Digital Mail System Inkjet Printer

(76) Inventor: Jeffery Scott Caudle, Concord, NC (US)

(21) Appl. No.: 12/612,339

(22) Filed: Nov. 4, 2009

(51) Int. Cl. B41L 45/00

(52) U.S. Cl. 101/47

(57) ABSTRACT

This invention relates to a printer that can feed, seal, and print an indicia (Postage Stamp) directly on a mailpiece or tapesheet using an inkjet printhead. Printer will be capable of feeding mailpieces either by hand, semi-automatically or a stack of mailpieces automatically; sealing each mailpiece if needed, and printing an indicia directly on the mailpiece using Internet-Based USPS approved software.

### FIELD OF THE INVENTION

The present invention relates exclusively to the domain of a printer that can feed, seal, and print an indicia (Postage Stamp) directly onto a mailpiece or tapesheet as it is transported all in one pass using inkjet printing technology. Printer will be capable of feeding mailpieces either by hand, semi-automatically or a stack of mailpieces automatically, sealing each mailpiece if needed, and printing an indicia (Postage Stamp) onto the mailpiece or tapesheet using Internet-Based USPS approved software.

### BACKGROUND OF THE INVENTION

Printers of the inkjet type are well known to the person skilled in the art. They allow the printing of postage stamps for mailpieces of different types (envelopes, postcards, etc.). These labels are then hand peeled and stuck on these articles one at a time.

However, up to the present time, no one has considered building a printer that can automatically feed mailpieces or tapesheets, print the indicia directly onto the mailpiece or tapesheet one at a time continuously, and seal said mailpieces if applicable all in one pass using Internet-Based USPS approved software.

### SUMMARY OF THE INVENTION

This invention relates to a printer for printing USPS approved indicia directly onto the mailpiece or tapesheet all in one pass automatically, comprising a base module using an inkjet printhead, the base comprising first transport means for conveying the mailpieces along a mailpiece-conveying path, from a mailpiece inlet towards said inkjet printhead module, characterized in that said dispensing means comprise at least a delivery inkjet cartridge for supplying ink.

### BRIEF DESCRIPTION OF THE DRAWINGS

The invention will be more readily understood on reading the following description given by way of indicative and non-limiting example, with reference to the accompanying drawings, in which:

FIG. 1 is a main view of printer from front with the touchscreen adjustable tilt display according to the invention.

FIG. 2 is a main view of printer from front without the touchscreen display built-in computer according to the invention.

FIG. 3 is a side view of printer showing the sealing slot for the envelope flap according to the invention.

FIG. 4 is a back view of printer according to the invention.

FIG. 5 is a front view of the inkjet printhead pattern of the inkjet printer according to the invention.

FIG. 6 is a back view of the belt pattern layout for the inkjet printer.

### DESCRIPTION OF PREFERRED EMBODIMENTS

An Internet Based Digital Mail System Printer is conventionally formed by a base with an inkjet printing module connected to this base. The Internet Based Digital Mail System Printer can also be comprised of a built in scale or interfaced external scale via a USB port that can weigh up to 70 lbs. Also, the said printer will be capable of sealing mailpieces automatically as the mailpiece is fed through the printer. The printer can be equipped with a built in touchscreen computer or interfaced with an external computer using USPS approved internet postage software via a USB port. Using the Internet Based Digital Mail System Printer, the operator determines the way each mailpiece is to be processed (IE First Class, Priority, Express, etc.), places the mailpiece onto the internal/external scale for proper rate calculation, places the mailpieces or tapesheets onto the feeder hopper insuring the envelope flaps of the mailpieces that need sealing are placed in the sealer slot of the feed hopper.

The printer is comprised of a feed photo sensor that when covered turns the main drive motor on to begin the process of conveying mailpieces or tapesheets through the printer. By placing a stack of mailpieces/mail transfer cards into the feeder hopper, the bottom piece is fed first automatically using a set of automatic adjusting separator fingers to insure each piece is fed one at a time. The mailpiece or tapesheet will then pass over a second photo sensor that will send a signal to the printhead to print the USPS approved indicia directly to the mailpiece or tapesheet. A third photo sensor is used to stop the mailpiece or tapesheet in the exact holding position by stopping main drive motor if necessary. Once the USPS approved indicia is printed directly on the mailpiece or tapesheet, the main drive motor will be start again and feed the mailpiece or tapesheet through a set of rollers into the sealer area. After exiting the pressure rollers, the envelope will pass through the sealer unit which will wet the envelope flap if needed and then be conveyed through a second set of pressure rollers to apply the right amount of pressure, assuring that the envelope is sealed completely and ejected safely out of the printer.

Referring now to the drawings,

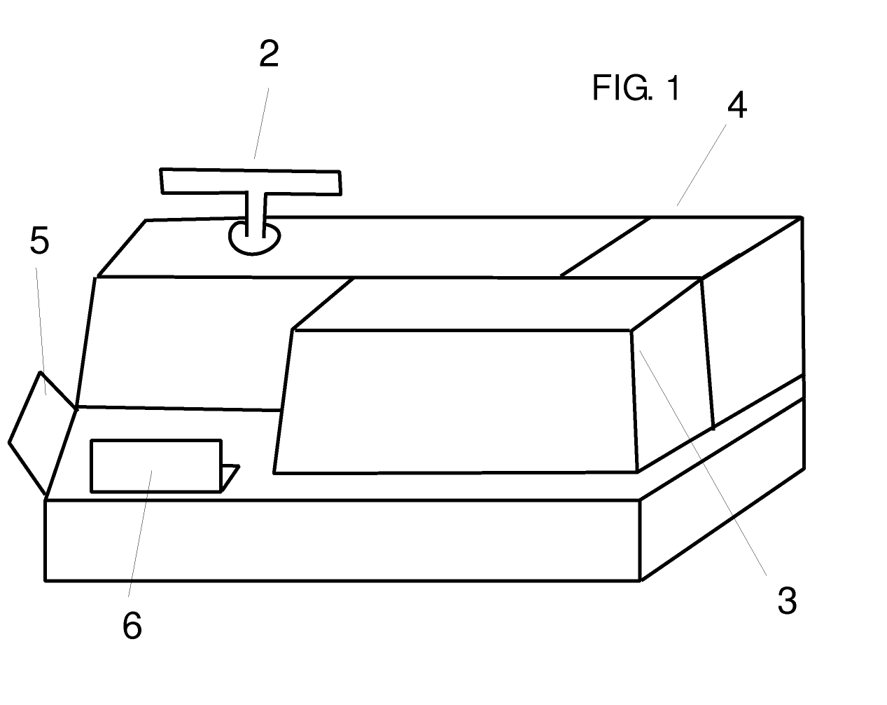

FIG. 1-4 are different views of what the outside of the printer can look like, but not limited to what the actual finished product will be.

FIG. 1 shows the proposed outside view from the front of the printer. The printer will be comprised of a hinged front compartment door 3 which will give access to change the ink cartridge. The water supply door 4 will give access to the water bottle for sealing the mailpieces as it passes through the printer. Also, the printer can include an integrated scale 2 which will have a capacity of up to 70 lb.s. The feeder will need a backstop 5 to help angle the stack of mailpieces. A side guide 6 is used to keep the mailpiece straight as it enters through the separator unit.

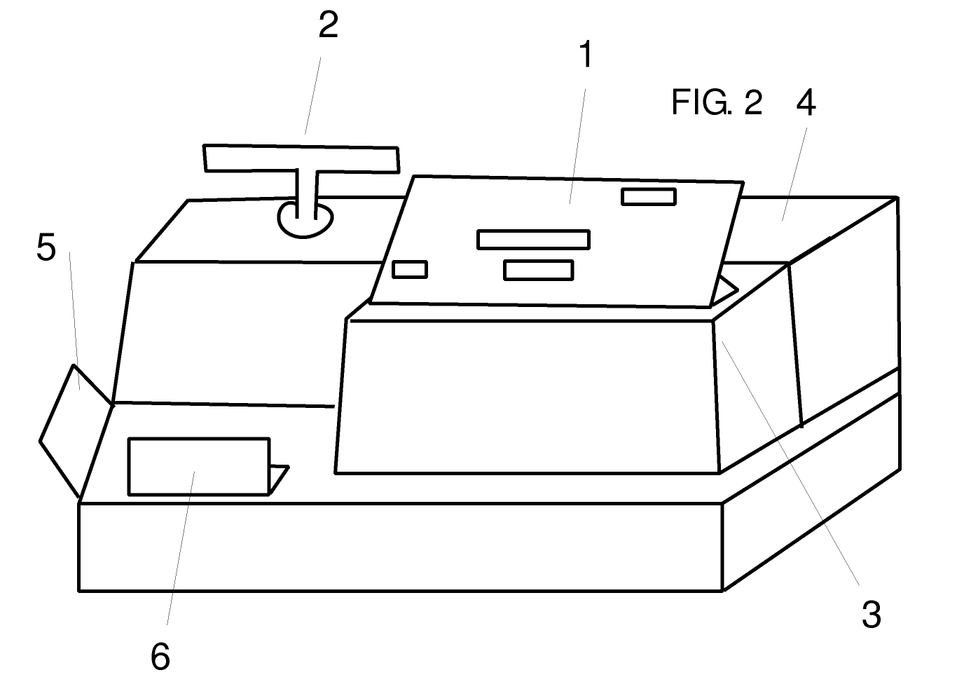

FIG. 2 shows the proposed outside view from the front of the printer. The printer can be comprised of a built in touchscreen 1 computer. Using the touchscreen option, the printer can be used as a stand alone system that will be operational with the use of a network jack to get internet access. A hinged front compartment door 3 will give access to change the ink cartridge. The water supply door 4 will give access to the water bottle for sealing the mailpieces as it passes through the printer. Also, the printer can include an integrated scale 2 which will have a capacity of up to 70 lb.s. The feeder will need a backstop 5 to help angle the stack of mailpieces. A side guide 6 is used to keep the mailpiece straight as it enters through the separator unit.

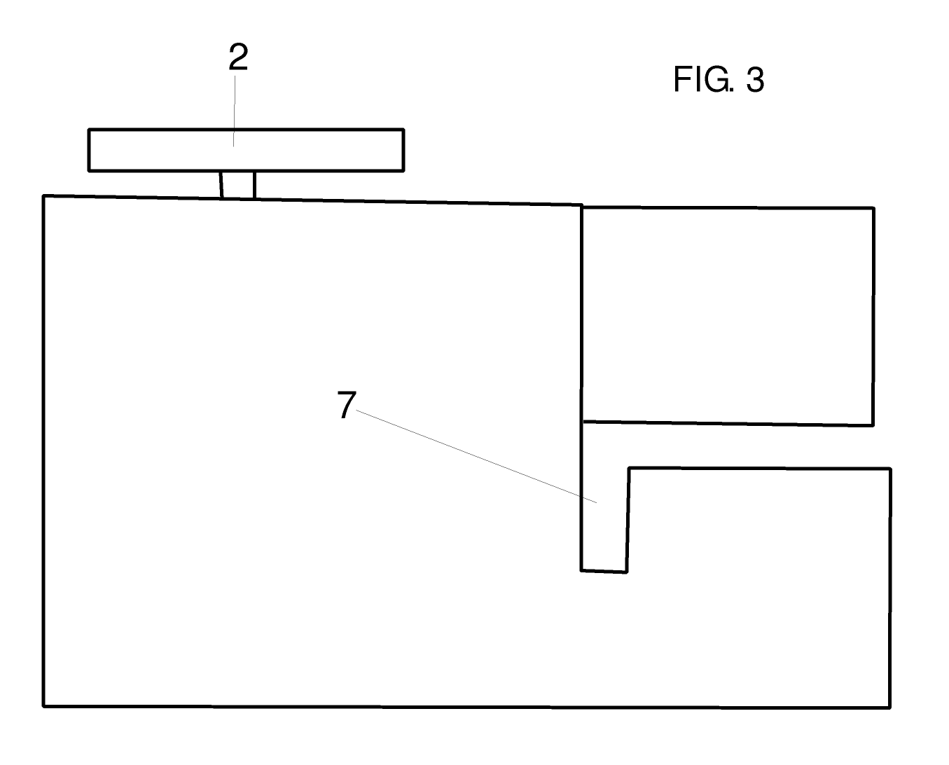

FIG. 3 shows the side view of the printer. This angle shows the slot 7 for the mailpiece flap. When the mailpiece flap is placed into the slot 7, the mailpiece flap will be sealed and closed as it exits the printer. Also shown is the side view of the scale platform 2.

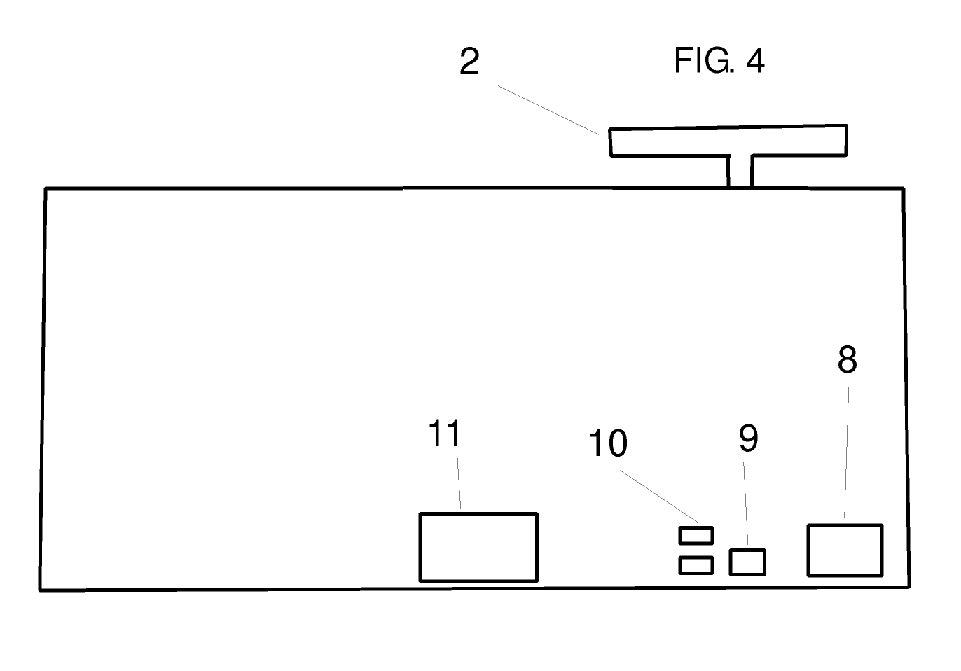

FIG. 4 shows the proposed back view of the printer. The back of the printer can consist of the main power receptacle 8, 2 or more, if applicable, USB ports 10 to interface with a computer, if necessary, and/or an external scale if the internal scale option isn't used. The printer will need to be comprised of a network jack 9 for internet access if the printer isn't interfaced with a computer. Each printer needs to have a serial tag sticker 11 with a unique serial number for tracking each printer.

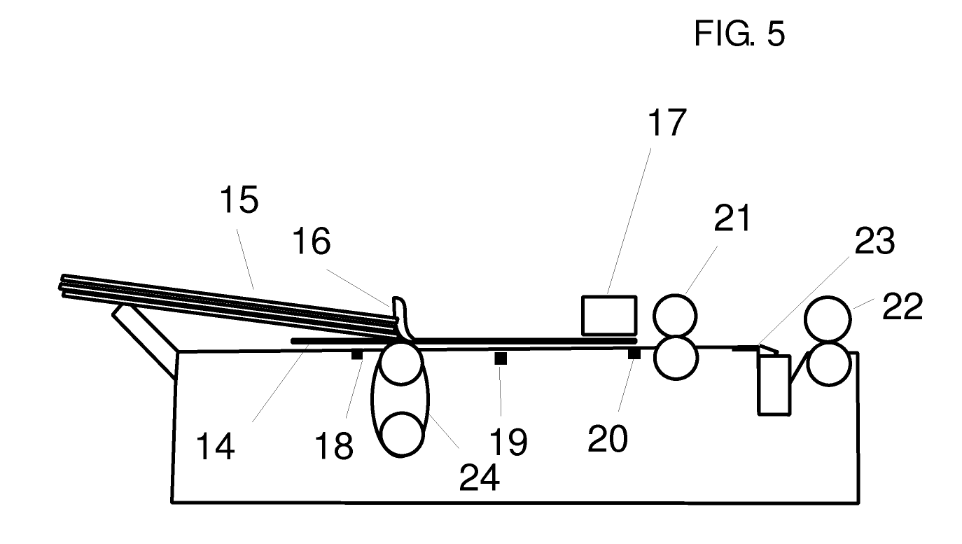

FIG. 5 schematically shows the front view of the inkjet printer without covers. This shows the path the mailpiece 14 or tapesheet as it is fed through the printer. As you can see, the stack 15 of mailpieces are placed onto the feed hopper covering the first photo sensor 18 which in turn starts the main drive motor. As the bottom mailpiece 14 is being fed into the printer, the separator fingers 16 hold back on the rest of the stack 15 of mailpieces to insure one mailpiece 14 enters the printer at a time. After the mailpiece 14 passes under the separator fingers 16, a second sensor 19 is covered which signals the computer to begin printing the USPS approved indicia. The mailpiece 14 then arrives at the third photo sensor 20 which stops the mailpiece 14 to print the indicia directly onto the mailpiece 14 if necessary. Once the main drive motor is turned back on, the printhead 17 sprays the indicia onto the mailpiece 14 and the mailpiece 14 is fed through the first set of pressure rollers 21. The mailpiece 14 is then fed through the sealer unit 23 to seal the mailpiece 14 if applicable and then through the second set of pressure rollers 22 to help press and seal the mailpiece 14 as it exits the printer.

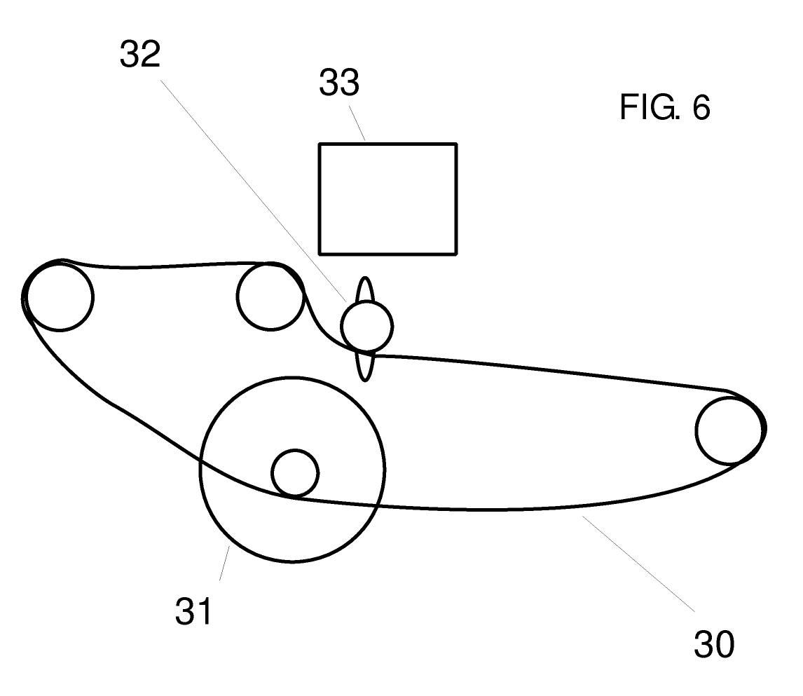

FIG. 6 schematically shows the back view of the printer's belt drive unit of the inkjet type. This displays the belt drive direction. The main drive belt 30 turns in a counter clockwise rotation when viewing the printer from the back. The main drive belt 30 uses a slotted/adjustable idler roller 32 to tighten the belt to the right tension. Also shown is the inket parking station 33 of the printhead unit.

I claim as my invention:

1. A printer for printing postage stamps from Internet based USPS approved indicia software directly onto a mailpiece or tapesheet. As mailpiece or tapesheet is placed in the input area, a photo-sensor will be covered and the main motor will begin to feed in said mailpiece or tapesheet. A second photo-sensor will signal the computer to print postage stamp (indicia). When mailpiece or tapesheet arrives at the printhead stage, a third photo-sensor will be covered to stop said mailpiece or tapesheet if necessary. After the postage stamp is printed on the mailpiece or tapesheet, the main motor will eject the mailpiece or tapesheet. Once the third photo-sensor is uncovered, the main drive motor will begin to feed the next piece and the process starts over again.

2. The printer of claim 1, can either use a built-in touchscreen computer screen or be interfaced with an external computer through a network interface jack.

3. The printer of claim 1, can be comprised of a scale module. The scale module can be comprised of a built-in or external scale that weighs mailpieces up to 70 lbs. By placing a mailpiece on the scale platform, the internet based USPS approved software will automatically calculate and display the price of the mailpiece.

4. The printer of claim 1, can be comprised of an envelope sealer module that interfaces with said printer. It will be capable of accepting both sealed and non sealed mailpieces. If the mailpiece needs to be sealed, operator slides mailpiece into sealing slot to seal envelopes as it passes through printer.

5. The printer of claim 1, can also be comprised of an automatic feed module that interfaces with either the sealer module or print module. The automatic feed module will use self-adjusting thickness separator fingers or stationary wheels to insure every mailpiece is fed in one at a time. A photo-sensor is used to turn main motor on to start the feeding of mailpieces that are placed in the feed hopper.
